(19) United States
(12) Patent Application Publication
(10) Pub. No.: US 2013/0330618 A1
(43) Pub. Date: Dec. 12, 2013

(54) BATTERY ELECTRODE AND BATTERY

(71) Applicants: Shoichiro Sakai, Osaka-shi (JP); Shinji Inazawa, Osaka-shi (JP); Koji Nitta, Osaka-shi (JP); Atsushi Fukunaga, Osaka-shi (JP)

(72) Inventors: Shoichiro Sakai, Osaka-shi (JP); Shinji Inazawa, Osaka-shi (JP); Koji Nitta, Osaka-shi (JP); Atsushi Fukunaga, Osaka-shi (JP)

(73) Assignee: SUMITOMO ELECTRIC INDUSTRIES, LTD., Osaka-shi, Osaka (JP)

(21) Appl. No.: 14/001,066

(22) PCT Filed: Feb. 16, 2012
(86) PCT No.: PCT/JP2012/053601

§ 371 Date: Aug. 22, 2013

(30) Foreign Application Priority Data
Feb. 22, 2011 (JP) 2011 035621

(51) Int. Cl. H01M 4/80; H01M 4/131

(52) U.S. Cl. CPC H01M 4/80; H01M 4/131
USPC 429/211

(57) ABSTRACT

Provided are a battery electrode with low internal resistance and a battery with high charge and discharge efficiency. The battery electrode includes a current collector formed of a porous metal having a three-dimensional network structure and an active material, and the active material is supported in the network structure of the current collector without using a binder resin.

### TECHNICAL FIELD

The present invention relates to battery electrodes and batteries.

### BACKGROUND ART

Electronic devices such as cellular phones, mobile personal computers, and digital cameras are rapidly becoming prevalent today, and there is a rapidly growing demand for compact secondary batteries. In the field of electricity and energy, large quantities of electricity are being generated from natural energy sources such as sunlight and wind, and secondary batteries for electricity storage are essential for compensating for an unstable supply of electricity depending on the climate and weather.

Secondary batteries for electronic devices and for electricity storage have been extensively researched by various organizations, and research has also been focused on the materials and structures of various components of secondary batteries. Among important components that determine battery performance are electrodes used as positive and negative electrodes.

### CITATION LIST

### Patent Literature

PTL 1: Japanese Unexamined Patent Application Publication No. 2007-273362

### SUMMARY OF INVENTION

### Technical Problem

Electrodes for electrolyte-type batteries such as lithium-ion batteries and nickel hydride batteries are typically manufactured by mixing an active material with a binder resin for supporting the active material on a current collector and then applying the mixture to the current collector. The battery electrode disclosed in PTL 1 above includes a metal foil such as an aluminum or copper foil as a current collector and a polyvinylidene fluoride (PVDF) binder resin as a binder for preventing the active material from coming off the current collector.

FIG. 1 is a sectional view schematically showing an example of a known battery electrode. This battery electrode includes a metal foil 4 as a current collector and also includes an active material 81 and a binder resin 9 that are mixed and applied to a surface of the metal foil 4. The binder resin 9 binds the active material 81 together and also binds the active material 81 with the metal foil 4 to prevent the active material 81 from coming off the metal foil 4 (current collector).

The role of the binder resin is to bind the active material with the current collector in the electrode. The binder resin, such as PVDF, however, is an insulator; it itself increases the internal resistance of the electrode and thus decreases the charge and discharge efficiency of the battery. If less (or no) binder resin is added to reduce the internal resistance, on the other hand, the active material easily comes off the current collector, thus providing decreased battery capacity.

For lithium-ion batteries and nickel hydride batteries, an aqueous binder system containing styrene-butadiene as a binder and carboxymethylcellulose (CMC) as a viscosity modifier is also used to reduce the internal resistance. This binder system, however, is insufficient in reducing the internal resistance and has a problem in that the double bonds of butadiene easily deteriorate due to oxidation in a positive electrode, where an oxidation reaction occurs. Another problem is that aqueous binders cannot be used for molten-salt batteries, which contain no aqueous solution.

In light of the foregoing problems, an object of the present invention is to provide a battery electrode with low internal resistance and a battery with high charge and discharge efficiency.

### Solution to Problem

A battery electrode according to the present invention includes a current collector formed of a porous metal having a three-dimensional network structure and an active material, and the active material is supported in the network structure of the current collector without using a binder resin (Claim 1).

This battery electrode allows the active material to be supported on the current collector without using a binder resin because the current collector is formed of a porous metal having a three-dimensional network structure. Thus, the battery electrode does not contain a binder resin, which is an insulator, so that it has low internal resistance.

Preferably, the current collector is formed of porous aluminum (Claim 2). To support the active material in the network structure of the current collector, it is effective to compress the current collector. When used as the material for the current collector, aluminum is more compressible than other metals. Aluminum is also suitable as a battery current collector because it is resistant to oxidation.

Preferably, the active material is at least one material selected from the group consisting of NaCrO₂, TiS₂, NaMnF₃, Na₂FePO₄F, NaVPO₄F, Na_{0.44}MnO₂, FeF₃, Sn, Si, graphite, and non-graphitizable carbon (Claim 3).

The above active materials can be used as active materials for molten-salt batteries because they can absorb and release a metal of a molten salt. Again, these active materials can be supported on the current collector without using a binder resin because the current collector is formed of a porous metal having a three-dimensional network structure. Thus, the battery electrode does not contain a binder resin, which is an insulator, so that it has low internal resistance when used as an electrode for a molten-salt battery.

A battery according to the present invention includes one of the above battery electrodes as at least any one of a positive electrode and a negative electrode (Claim 4).

This reduces charge-discharge loss because the electrode has low internal resistance, and improves the charge and discharge efficiency of the battery.

### Advantageous Effects of Invention

The present invention reduces the internal resistance of a battery electrode and also improves the charge and discharge efficiency of a battery.

### BRIEF DESCRIPTION OF DRAWINGS

FIG. 1 is a sectional view schematically showing an example of a known battery electrode.

FIG. 2 is a diagram schematically showing an example of an electrode of the present invention.

FIG. 3 is a top view schematically showing an example of the structure of a molten-salt battery.

FIG. 4 is a schematic transparent view of the molten-salt battery as viewed in a front view.

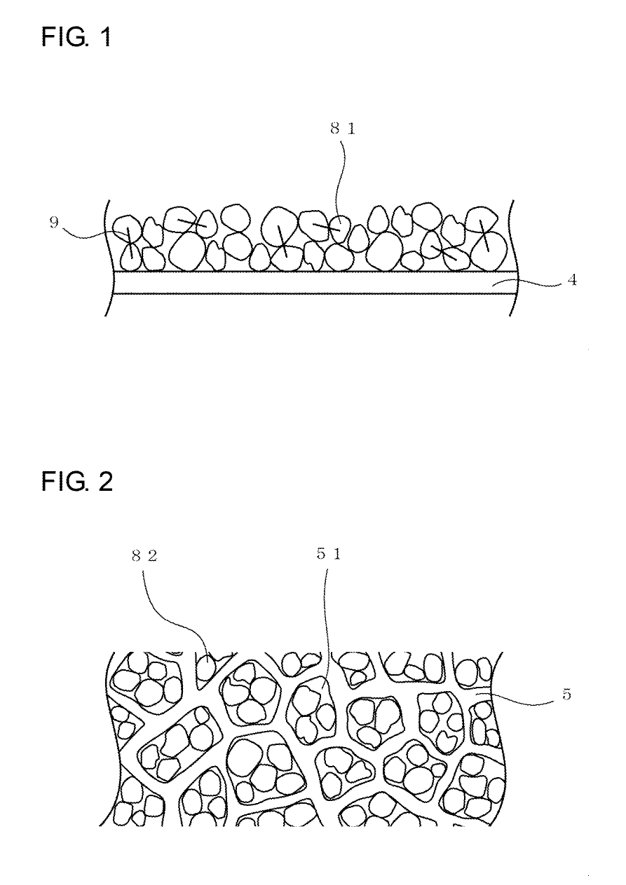

### REFERENCE SIGNS LIST

11 positive electrode

12, 22 tab

13, 23 tab lead

21 negative electrode

31 separator

4 metal foil

5 porous metal

51 internal space

6 battery case

61, 62 sidewall

7 molten salt

81, 82 active material

9 binder resin

### DESCRIPTION OF EMBODIMENTS

The present invention will now be described based on embodiments. The present invention should not be construed as being limited to the following embodiments. Various modifications can be made to the following embodiments within the scope of the present invention and equivalents thereof

FIG. 2 is a diagram schematically showing an example of an electrode of the present invention. This electrode includes a porous metal 5 as a current collector. Although the porous metal 5 is schematically shown in two dimensions in FIG. 2, the porous metal of the present invention has a three-dimensional network structure in which the porous shape also extends in the direction perpendicular to the figure. Internal spaces 51 enclosed by the porous metal 5 are filled with an active material 82.

The porous metal 5 is preferably aluminum, which is resistant to corrosion by molten salts and is also resistant to oxidation. Examples of porous aluminum materials include aluminum nonwoven fabric, which is composed of tangled aluminum fibers, aluminum foam, which is produced by foaming aluminum, and Celmet® (hereinafter referred to as “aluminum Celmet”), which is produced by forming an aluminum layer on a resin foam and then decomposing the resin foam.

Examples of active materials 82 for positive electrodes include NaCrO₂, TiS₂, NaMnF₃, Na₂FePO₄F, NaVPO₄F, Na_{0.44}MnO₂, and FeF₃, and examples of active materials 82 for negative electrodes include Sn, Si, graphite, and non-graphitizable carbon.

The porosity of the porous metal 5, i.e., the volume percentage of the internal spaces 51 in the porous metal 5, is preferably, but not limited to, about 80% to about 98%. The pore size is preferably, but not limited to, about 50 to about 1,000 μm. To fill the porous metal (current collector) 5 with the active material 82, the particle size of the active material 82 needs to be smaller than the pore size of the porous metal 5.

The electrode of this embodiment is fabricated by dipping the porous metal 5 in a mixture of the active material 82 and liquid pyrrolidone and then sufficiently drying the porous metal 5. To prevent the active material 82 from coming off, it is effective to compress the electrode in the thickness direction later. Compressing the electrode deforms the porous metal 5 so that the internal spaces 51 become smaller than before compression. Compressing the electrode also causes the active material 82 to be aggregated and twined on the porous metal 5 so that the active material 82 does not easily come off the electrode.

To effectively prevent the active material 82 from coming off, the compression rate of the electrode (=(thickness before compression—thickness after compression)/thickness before compression) is preferably 10% or more. An excessively high compression rate, however, results in insufficient battery capacity because the porous metal 5 has decreased porosity and cannot contain a sufficient amount of active material 82; therefore, the compression rate is preferably 80% or less. Aluminum is also suitable as a current collector material for the present invention in that it is more compressible than other metals.

As described above, the active material can be supported on the current collector without using a binder resin because the current collector is formed of a porous metal having a three-dimensional network structure and, additionally, the electrode is effectively compressed. Thus, the battery electrode does not contain a binder resin, which is an insulator, so that it has low internal resistance.

The electrode of the present invention may be used either as each of a positive electrode and a negative electrode of a battery or as one of a positive electrode and a negative electrode of a battery. For example, the electrode of the present invention as shown in FIG. 2 may be used as a positive electrode of a battery, and a known electrode such as a Sn—Na alloy sheet based on aluminum coated with tin, which is a negative electrode active material, may be used as a negative electrode.

Next, the structure of a molten-salt battery will be described as an example of a battery including the electrode of the present invention.

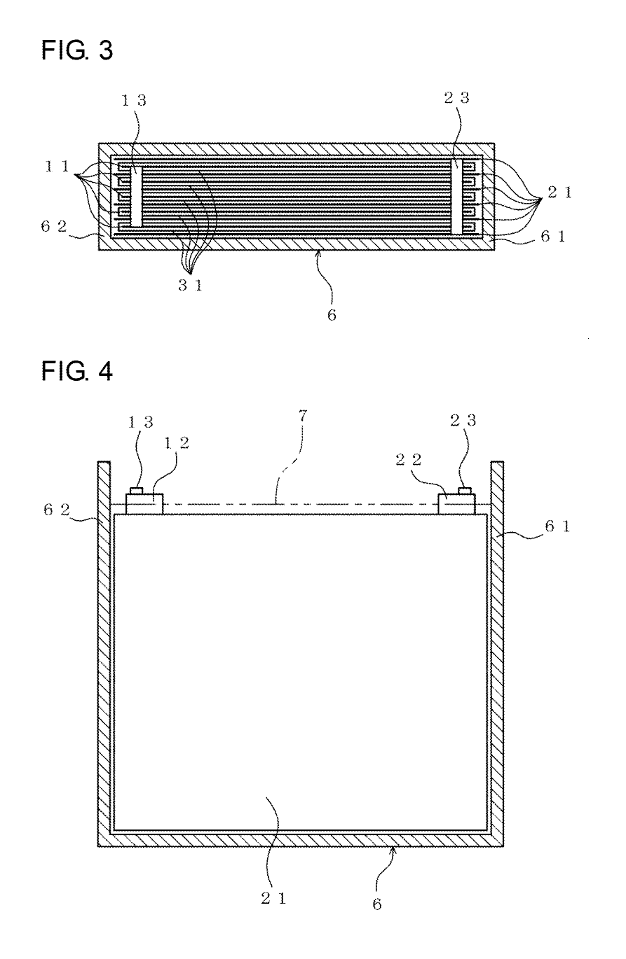

FIG. 3 is a top view schematically showing an example of the structure of a molten-salt battery, and FIG. 4 is a schematic transparent view of the molten-salt battery in FIG. 4 as viewed in a front view. In the figures, an aluminum alloy battery case, denoted by 6, has a hollow, substantially rectangular shape with a closed bottom. The interior of the battery case 6 is finished by insulation treatment such as fluoropolymer coating or alumite treatment. The battery case 6 contains six negative electrodes 21 and five positive electrodes 11 accommodated in different bag-shaped separators 31 such that the negative electrodes 21 and the positive electrodes 11 are arranged in the lateral direction (front-to-back direction in FIG. 4). In FIG. 3, five generator elements are stacked, each composed of one negative electrode 21, one separator 31, and one positive electrode 11.

The bottom end of a rectangular tab (conductor) 22 for outputting current is bonded to the top ends of the negative electrodes 21 near one sidewall 61 of the battery case 6. The top end of the tab 22 is bonded to the bottom surface of a rectangular flat tab lead 23. The bottom end of a rectangular tab 12 for outputting current is bonded to the top ends of the positive electrodes 11 near the other sidewall 62 of the battery case 6 respectively. The top end of the tab 12 is bonded to the bottom surface of a rectangular flat tab lead 13. Thus, the five generator elements, composed of the negative electrodes 21, the separators 31, and the positive electrodes 11, are connected in parallel.

The tab leads 13 and 23 function as external electrodes for connecting the generator elements in their entirety, including the stack of positive and negative electrodes 11, 21, to an external electrical circuit and are positioned above the liquid level of a molten salt 7.

The separators 31 are formed of a glass nonwoven fabric resistant to molten salts at the operating temperature of the molten-salt battery and are porous and bag-shaped. The separators 31, together with the negative electrodes 21 and the positive electrodes 11, are dipped about 10 mm below the liquid level of the molten salt 7 contained in the substantially rectangular battery case 6. This allows for a slight decrease in liquid level.

The constituents of the molten salt 7 are, but not limited to, bis(fluorosulfonyl)imide (FSI) or bis(trifluoromethylsulfonyl)imide (TFSI) anion and at least any one of sodium and potassium cation.

In the above structure, the entire battery case is heated to a predetermined temperature (for example, 85° C. to 95° C.) by external heating means (not shown) to melt the molten salt 7, thereby enabling charging and discharging.

### EXAMPLES

Next, the present invention will be described in greater detail based on the Examples.

### Example 1

As an example, a molten-salt battery as shown in FIGS. 3 and 4 was constructed. In this example, the positive electrodes were electrodes having the structure shown in FIG. 2. The positive electrode active material was NaCrO₂, the current collector was aluminum Celmet, and a binder resin such as PVDF was not used. The active material had an average particle size of about 10 ∥m. The aluminum Celmet had an average pore size of about 600 μm and a thickness of 1 mm and was compressed to a thickness of 0.7 mm (compression rate: 30%). The negative electrodes were Sn—Na alloy sheets based on tin-coated aluminum. The separators were formed of a glass nonwoven fabric.

A charge-discharge test was carried out on the thus-fabricated molten-salt battery to determine the voltage efficiency. The voltage efficiency was calculated from the charge-discharge voltage characteristics by (discharge voltage at half of full charge)/(charge voltage at half of full charge), and the lower the internal resistance of the battery, the higher the voltage efficiency. The test temperature was 90° C., and the charge-discharge rate was 0.1 C. Because 1 C means that a full charge takes one hour, 0.1 C means that a full charge takes ten hours. The test results for this example showed that the voltage efficiency was 91%.

### Comparative Example 1

As a comparative example, a molten-salt battery was fabricated under the same conditions as in Example 1 except that PVDF was used as a binder resin for the positive electrodes, and a charge-discharge test was carried out under the same conditions as in Example 1. The test results for the comparative example showed that the voltage efficiency was 85%.

The results for Example 1 and Comparative Example 1 demonstrated that the battery of Example 1, in which no binder resin was used, had a higher voltage efficiency and thus had a lower internal resistance.

1. A battery electrode comprising a current collector comprising a porous metal having a three-dimensional network structure and an active material,
wherein the active material is supported in the network structure of the current collector without using a binder resin.

2. The battery electrode according to claim 1, wherein the current collector comprises porous aluminum.

3. The battery electrode according to claim 1, wherein the active material is at least one material selected from the group consisting of NaCrO₂, TiS₂, NaMnF₃, Na₂FePO₄F, NaVPO₄F, Na_{0.44}MnO₂, FeF₃, Sn, Si, graphite, and non-graphitizable carbon.

4. A battery comprising the battery electrode according to claim 1 as at least any one of a positive electrode and/or and a negative electrode.
